(19) United States
(12) Patent Application Publication
(10) Pub. No.: US 2015/0168725 A1
(43) Pub. Date: Jun. 18, 2015

(54) HEAD MOUNTED DISPLAY DEVICE AND METHOD OF CONTROLLING HEAD MOUNTED DISPLAY DEVICE

(71) Applicant: SEIKO EPSON CORPORATION, Tokyo (JP)

(72) Inventor: Fusashi KIMURA, Matsumoto-shi (JP)

(21) Appl. No.: 14/555,880

(22) Filed: Nov. 28, 2014

(30) Foreign Application Priority Data
Dec. 13, 2013 (JP) 2013-257674

(51) Int. Cl. G02B 27/01; G06F 3/041

(52) U.S. Cl. CPC G02B 27/017; G06F 3/041

(57) ABSTRACT

A head mounted display device includes an operation unit that receives an operation, a first detection unit that detects an operation unit state as at least one of a location and an orientation of the operation unit, an image display unit that forms image light based on image data and allows a user to visually recognize the image light as a virtual image when worn on a head of the user, a second detection unit that detects a display unit state as at least one of a location and an orientation of the image display unit, and a control unit that performs a first control based on the detected operation unit state and performs a second control different from the first control based on the detected display unit state with respect to the head mounted display device.

### BACKGROUND

1. Technical Field

The present invention relates to a head mounted display device.

2. Related Art

Head mounted display devices (head mounted displays, HMDs) as display devices worn on heads have been known. For example, the head mounted display device generates image light representing an image using a liquid crystal display and a light source, guides the generated image light to an eye of a user using a projection system and a light guide plate, and thereby, allows the user to visually recognize a virtual image. As means for controlling the head mounted display device, operations using a button and a track pad, motions of the head of the user detected by various sensors, etc. have been known.

Patent Document 1 (JP-A-2011-82781) discloses a head mounted display device having a gyro sensor provided inside of a remote as an operation unit and operated in response to an angular velocity detected by the gyro sensor. Further, Patent Document 2 (JP-A-5-305181) discloses a game machine by which a plurality of players experience the same game and head mounted display devices are detachable from the main body of the game machine for facilitation of disinfection of the head mounted display devices.

In the head mounted display device disclosed in Patent Document 1, the operation of the head mounted display device may be performed using the gyro sensor in the operation unit. However, there is a problem that, when another sensor than the gyro sensor in the operation unit is provided, it is impossible to perform another operation than the operation using the angular velocity detected by the gyro sensor in response to the detection result of the other sensor. Further, there is a problem that it is impossible, with respect to detection results of the plurality of sensors, to perform a plurality of controls corresponding to the respective detection results depending on the operating system (hereinafter, also simply referred to as “OS”) and impossible to perform the plurality of controls without changing the OS itself.

### SUMMARY

An advantage of some aspects of the invention is to solve at least a part of the problems described above, and the invention can be implemented as the following aspects.

(1) An aspect of the invention provides a head mounted display device. The head mounted display device includes an operation unit that receives an operation, a first detection unit that detects an operation unit state as at least one of a location and an orientation of the operation unit, an image display unit that forms image light based on image data and allows a user to visually recognize the image light as a virtual image when worn on a head of the user, a second detection unit that detects a display unit state as at least one of a location and an orientation of the image display unit, and a control unit that performs a first control based on the detected operation unit state and performs a second control different from the first control based on the detected display unit state with respect to the head mounted display device. According to the head mounted display device of the aspect, with respect to detection results of the plurality of detection units, a plurality of controls corresponding to the respective detection results may be performed.

(2) In the head mounted display device of the aspect described above, the first detection unit may be provided in the operation unit, and the second detection unit may be provided in the image display unit. According to the head mounted display device of the aspect, operations corresponding to the plurality of detection results detected by the first detection unit provided in the operation unit and the second detection unit provided in the image display unit separate from the operation unit are performed, and thereby, the operations are not complex for the user, the user may intuitively perform the operations, and the convenience of the user is improved.

(3) In the head mounted display device of the aspect described above, the first detection unit may detect a change in location of the operation unit as the operation unit state, and the second detection unit may detect a change in orientation of the image display unit as the display unit state. According to the head mounted display device of the aspect, the plurality of operations are performed according to the change of the operation part, the change in line-of-sight direction of the user, and the change of the head, and thereby, the user may intuitively perform the operations and the convenience of the user is improved.

(4) In the head mounted display device of the aspect described above, the control unit may exclusively perform the first control and the second control. According to the head mounted display device of the aspect, when the plurality of detection results are respectively processed by the plurality of detection units, the control based on one detection result is performed by the control unit. Thus, it is not necessary to change software itself of an operating system (OS) as basic software incapable of controls corresponding to the plurality of detection results and the development period of the head mounted display device may be made shorter.

(5) In the head mounted display device of the aspect described above, the control unit may perform one of the first control and the second control when the change in location of the operation unit is detected and the change in orientation of the display unit is detected. According to the head mounted display device of the aspect, when the plurality of detection results are respectively processed by the plurality of detection units, the control based on one detection result is preferentially performed, and thereby, erroneous motions of the head mounted display device may be reduced.

(6) In the head mounted display device of the aspect described above, the control unit may time-divisionally perform the first control and the second control. According to the head mounted display device of the aspect, although the control unit performs processing corresponding to one detection result only at a specific time with respect to the detection results of the plurality of detection units, a plurality of processings are continuously performed on the result of the processing. Thus, while the load of the processing on the control unit at the specific time is suppressed, the continuous output processing may be performed.

(7) In the head mounted display device of the aspect described above, the head mounted display device may further include an imaging unit that images an outside scenery, and the second control may be processing of changing a direction in which imaging is performed by the imaging unit based on the change in orientation of the image display unit. According to the head mounted display device of the aspect, the line-of-sight direction of the user specified according to the orientation of the image display unit and the imaging direction of the imaging unit are associated, and thereby, the imaging direction may be naturally changed in response to the direction in which the user desires visual recognition and the convenience of the user is improved.

(8) In the head mounted display device of the aspect described above, at least one of the first control and the second control is processing of controlling the image light. According to the head mounted display device of the aspect, the image light visually recognized by the user changes in response to the operation and the state change of the user, and thereby, the convenience of the user is improved.

Not all of the plurality of component elements of the above described respective aspects of the invention are essential. In order to solve part or all of the above described problems or in order to achieve part or all of the advantages described in the specification, some component elements of the plurality of the component elements may be appropriately changed, deleted, replaced by new other component elements, partially deleted in limitations. Further, in order to solve part or all of the above described problems or in order to achieve part or all of the advantages described in the specification, part or all of the technological features contained in above described one aspect of the invention may be combined with part or all of the technological features contained in the above described other aspects of the invention into one independent aspect of the invention.

For example, one aspect of the invention may be implemented as a device including one or more, or all of the five elements of the operation unit, the first detection unit, the image display unit, the second detection unit, and the control unit. That is, the device may have the operation unit or not. Further, the device may have the first detection unit or not. Furthermore, the device may have the image display unit or not. Or, the device may have the second detection unit or not. Or, the device may have the control unit or not. The operation unit may receive operations, for example. The first detection unit may detect an operation unit state as at least one of a location and an orientation of the operation unit, for example. The image display unit may form image light based on image data and allows a user to visually recognize the image light as a virtual image when worn on a head of a user, for example. The second detection unit may detect a display unit state as at least one of a location and an orientation of the image display unit, for example. The control unit may perform a first control based on the detected operation unit state and a second control different from the first control based on the detected display unit state with respect to the head mounted display device, for example. The device may be implemented as a head mounted display device, for example, and may be implemented as other devices than the head mounted display device. According to the aspect, at least one of various challenges including improvement and simplification in operability of the device, integration of the device, improvement in convenience of the user using the device may be resolved. Any of part or all of the technical features of the respective aspects of the head mounted display device described above may be applied to the device.

The invention may be implemented in other various aspects than the head mounted display device. For example, the invention may be implemented in forms of a method of controlling the head mounted display device, a head mounted display system, a computer program for implementation of the head mounted display system, a recording medium recording the computer program, data signals embodied within carrier wave containing the computer program, etc.

### BRIEF DESCRIPTION OF THE DRAWINGS

The invention will be described with reference to the accompanying drawings, wherein like numbers reference like elements.

FIG. 1 is an explanatory diagram showing a schematic configuration of a remote operation system using a head mounted display device in an embodiment of the invention.

FIG. 2 is an explanatory diagram showing an outer configuration of the head mounted display device.

FIG. 3 is a block diagram functionally showing a configuration of the head mounted display device.

FIG. 4 is an explanatory diagram showing image lights output by an image light generation part.

FIG. 5 is an explanatory diagram showing an outer configuration of a radio control car.

FIG. 6 is an explanatory diagram showing a flow of remote operation processing.

FIG. 7 is an explanatory diagram showing an example of a visual range visually recognized by a user in the remote operation processing.

FIG. 8 is an explanatory diagram showing an example of an angular velocity of a control unit, which changes according to operations by the user.

FIG. 9 is an explanatory diagram showing an example of the visual range visually recognized by the user in the remote operation processing.

FIG. 10 is an explanatory diagram showing relationships between time and processing in processings time-divisionally performed.

FIGS. 11A and 11B are explanatory diagrams showing outer configurations of head mounted display devices in modified examples.

### DESCRIPTION OF EXEMPLARY EMBODIMENTS

Next, embodiments of the invention will be explained in the following order.

A. Embodiment

A-1. Configuration of Remote Operation System:

A-2. Configuration of Head mounted Display Device:

A-3. Configuration of Radio Control Car:

A-4. Remote Operation Processing:

B. Modified Examples:

### A. EMBODIMENT

### A-1. Configuration of Remote Operation System

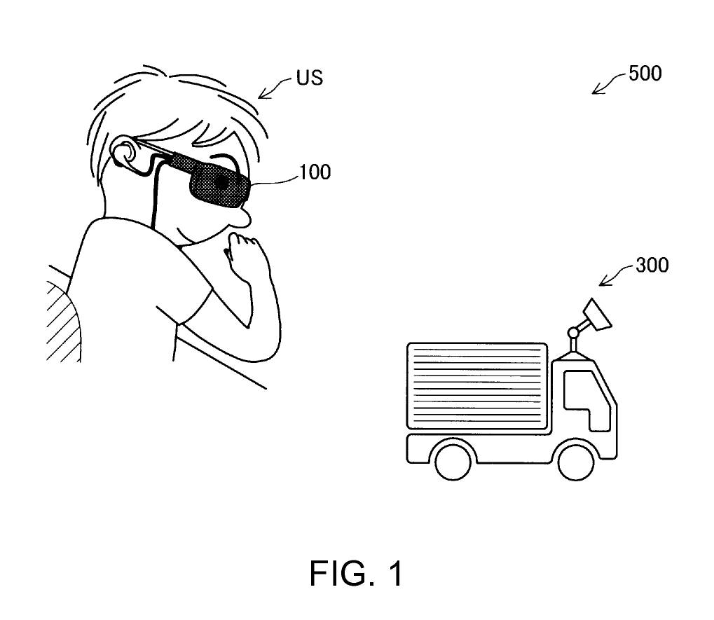

FIG. 1 is an explanatory diagram showing a schematic configuration of a remote operation system 500 using a head mounted display device 100 in an embodiment of the invention. In the remote operation system shown in FIG. 1, a user US of the head mounted display device 100 operates the head mounted display device 100, and thereby, may remotely operate a radio control car 300. The details of the configurations of the head mounted display device 100 and the radio control car 300 will be described later. A communication part in the head mounted display device 100 and a communication part in the radio control car 300 transmit and receive control signals between the head mounted display device 100 and the radio control car 300, and thereby, the user may remotely operate the radio control car 300. Note that, in the embodiment, the radio control car 300 is a device different from the head mounted display device 100, however, in place of the radio control car 300, a part of the head mounted display device 100 may be remotely controlled.

### A-2. Configuration of Head Mounted Display Device

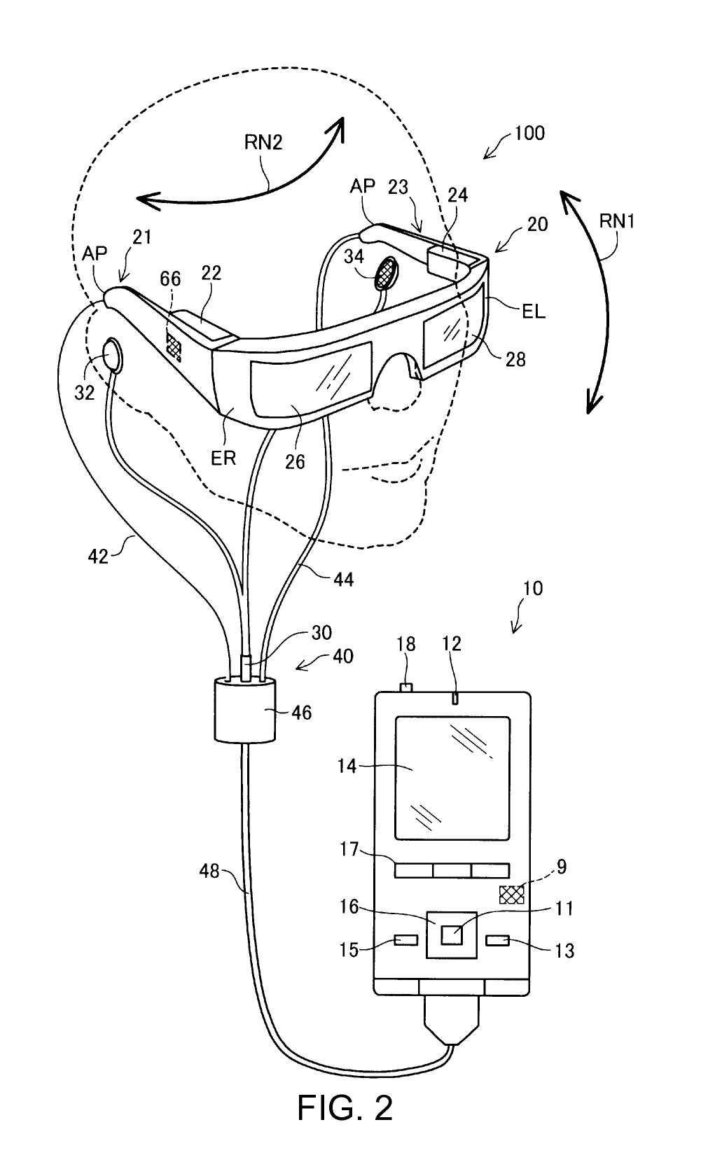

FIG. 2 is an explanatory diagram showing an outer configuration of the head mounted display device 100. The head mounted display device 100 is a display device worn on a head and also called a head mounted display (HMD). The head mounted display device 100 of the embodiment is an optically-transmissive head mounted display device that enables visual recognition of a virtual image and direct visual recognition of an outside scenery. Note that, in the specification, the virtual image visually recognized by the user US using the head mounted display device 100 is also referred to as “displayed image” for convenience. Further, output of image light generated based on image data is also referred to as “display of image”.

The head mounted display device 100 includes an image display unit 20 allows the user US to visually recognize a virtual image when worn on the head of the user US, and a control unit 10 (controller 10) that controls the image display unit 20.

The image display unit 20 is a wearable unit worn on the head of the user US and has a spectacle shape in the embodiment. The image display unit 20 includes a right holding part 21, a right display drive part 22, a left holding part 23, a left display drive part 24, a right optical image display part 26, a left optical image display part 28, and a 10-axis sensor 66 as a position sensor. The right optical image display part 26 and the left optical image display part 28 are provided to be located in front of the right and left eyes of the user US when the user US wears the image display unit 20, respectively. One end of the right optical image display part 26 and one end of the left optical image display part 28 are connected to each other in a location corresponding to the glabella of the user US when the user US wears the image display unit 20.

The right holding part 21 is a member provided to extend from an end part ER as the other end of the right optical image display part 26 to the location corresponding to the temporal part of the user US when the user US wears the image display unit 20. Similarly, the left holding part 23 is a member provided to extend from an end part EL as the other end of the left optical image display part 28 to the location corresponding to the temporal part of the user US when the user US wears the image display unit 20. The right holding part 21 and the left holding part 23 hold the image display unit 20 on the head of the user US like temples of spectacles.

The right display drive part 22 and the left display drive part 24 are provided at the sides opposed to the head of the user US when the user US wears the image display unit 20. Note that, as below, the right holding part 21 and the left holding part 23 are also collectively and simply referred to as “holding parts”, the right display drive part 22 and the left display drive part 24 are also collectively and simply referred to as “display drive parts”, and the right optical image display part 26 and the left optical image display part 28 are also collectively and simply referred to as “optical image display parts”.

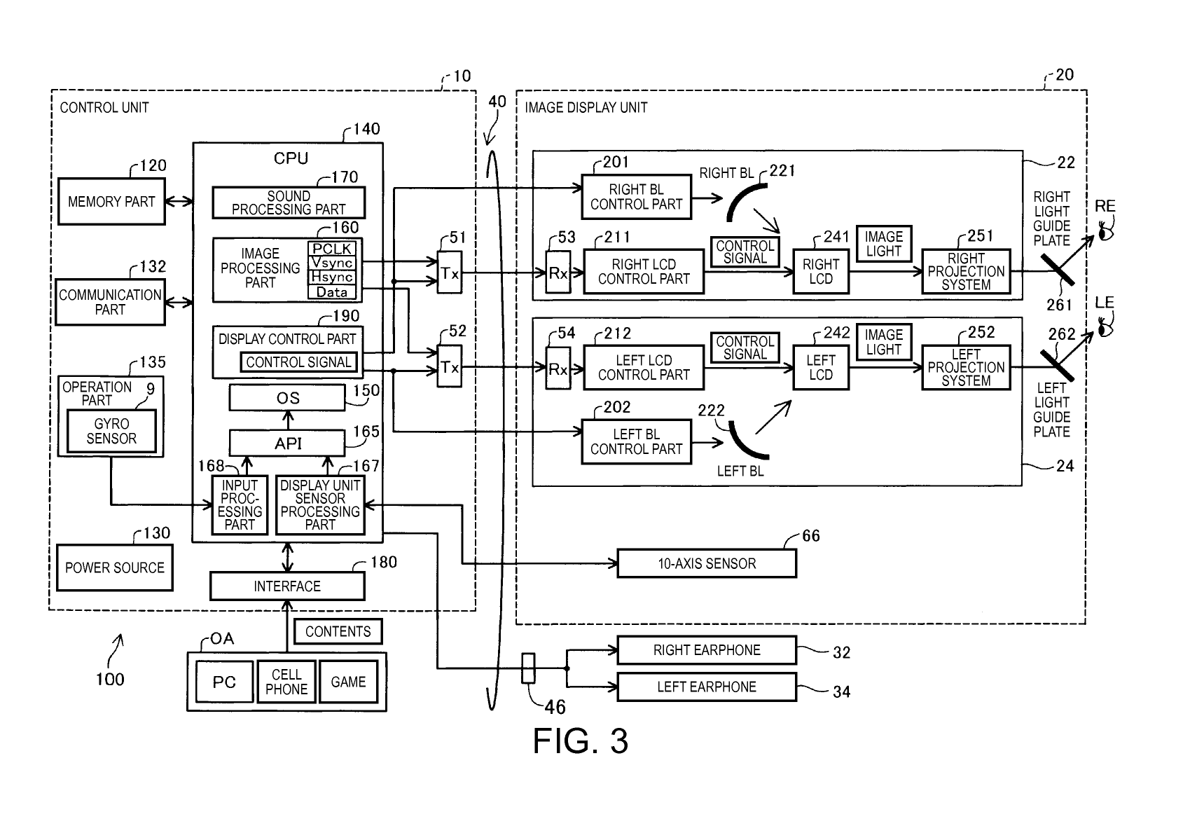

The display drive parts 22, 24 include liquid crystal displays 241, 242 (hereinafter, also referred to as “LCDs 241, 242”), projection systems 251, 252, and the like (see FIG. 3). The details of the configurations of the display drive parts 22, 24 will be described later. The optical image display parts 26, 28 as optical members include light guide plates 261, 262 (see FIG. 3) and a dimming plate. The light guide plates 261, 262 are formed using a light-transmissive resin material or the like and guide image lights output from the display drive parts 22, 24 to the eyes of the user US. The dimming plate is an optical device having a thin plate shape and provided to cover the front side of the image display unit 20 as the opposite side to the sides of the eyes of the user US. The dimming plate protects the light guide plates 261, 262 and suppresses damage, attachment of dirt, or the like to the light guide plates 261, 262. Further, by adjustment of light transmittance of the dimming plate, the amount of outside light entering the eyes of the user US may be adjusted and the ease of visual recognition of the virtual image may be adjusted. Note that the dimming plate is dispensable.

The 10-axis sensor 66 as the position sensor detects acceleration (three axes), angular velocities (three axes), geomagnetism (three axes), and atmospheric pressure (one axis). The 10-axis sensor 66 is provided inside near the display drive part 22 in the image display unit 20 and detects the motion and the location of the head of the user US (hereinafter, simply referred to as “state of image display unit 20”) when the image display unit 20 is worn on the head of the user US. The 10-axis sensor 66 may detect the motion along a trajectory RN1 in which the user US moves the head vertically and the motion along a trajectory RN2 in which the user US moves the head horizontally.

The image display unit 20 further has a connection unit 40 for connecting the image display unit 20 to the control unit 10. The connection unit 40 includes a main body cord 48 connected to the control unit 10, a right cord 42, a left cord 44, and a coupling member 46. The right cord 42 and the left cord 44 are cords bifurcated from the main body cord 48. The right cord 42 is inserted into a casing of the right holding part 21 from an end part AP in the extension direction of the right holding part 21 and connected to the right display drive part 22. Similarly, the left cord 44 is inserted into a casing of the left holding part 23 from an end part AP in the extension direction of the left holding part 23 and connected to the left display drive part 24. The coupling member 46 is provided at the bifurcation point of the main body cord 48 and the right cord 42 and the left cord 44, and has a jack for connection of an earphone plug 30. From the earphone plug 30, a right earphone 32 and a left earphone 34 extend.

The image display unit 20 and the control unit 10 perform transmission of various signals via the connection unit 40. Connectors (not shown) fitted in each other are respectively provided in the end part in the main body cord 48 opposite to the coupling member 46 and the control unit 10. By fit/unfit of the connector of the main body cord 48 and the connector of the control unit 10, the control unit 10 and the image display unit 20 are connected or disconnected. For example, metal cables and optical fibers may be employed for the right cord 42, the left cord 44, and the main body cord 48.

The control unit 10 is a device for controlling the head mounted display device 100. The control unit 10 includes an enter key 11, a lighting part 12, a display change key 13, a track pad 14, a brightness change key 15, an arrow key 16, a menu key 17, a power switch 18, and a gyro sensor 9 as a sensor that detects a location and a change in location of the control unit 10. The enter key 11 detects a press operation and outputs a signal for deciding the contents operated in the control unit 10. The lighting part 12 notifies the user of the operation status of the head mounted display device 100 by its emission state. The operation status of the head mounted display device 100 includes ON/OFF of power, for example. As the lighting part 12, for example, an LED (Light Emitting Diode) is used. The display change key 13 detects a press operation and outputs a signal for switching the display mode of content video between 3D and 2D, for example. The track pad 14 detects the operation of the finger by the user US on the operation surface of the track pad 14 and outputs a signal in response to the detected operation. As the track pad 14, various track pads of electrostatic type, pressure detection type, and optical type may be employed. The brightness change key 15 detects a press operation and outputs a signal for increasing and decreasing the brightness of the image display unit 20. The arrow key 16 detects a press operation for the key corresponding to up, down, right and left and outputs a signal in response to the detected operation. The power switch 18 detects a slide operation of the switch, and thereby, switches the power-on state of the head mounted display device 100. The gyro sensor 9 detects the angle and the angular velocity of the control unit 10. That is, the gyro sensor 9 detects changes in location of the control unit 10. For the purpose, the gyro sensor 9 detects changes in orientation and changes in location of the control unit 10 when the control unit 10 is moved. Note that the angle and the angular velocity of the control unit 10 detected by the gyro sensor 9 correspond to an operation unit state in the appended claims.

FIG. 3 is a block diagram functionally showing a configuration of the head mounted display device 100. As shown in FIG. 3, the control unit 10 has a communication part 132, a memory part 120, a power source 130, an operation part 135, a CPU 140, an interface 180, a transmission part 51 (Tx 51), and a transmission part 52 (Tx 52). The operation part 135 receives operations by the user US and includes the enter key 11, the display change key 13, the track pad 14, the brightness change key 15, the arrow key 16, the menu key 17, the power switch 18, and the gyro sensor 9.

The communication part 132 transmits signals to the communication part of the radio control car 300 via wireless communication and receives signals from the radio control car 300. In the embodiment, the communication part 132 performs wireless communication with the radio control car 300 using radio wave, however, in other embodiments, may perform wireless communication using light including infrared light and laser and sound including ultrasonic wave. Further, the wireless communication may be made according to predetermined wireless communications standards including wireless LAN and Bluetooth.

The power source 130 supplies power to the respective units of the head mounted display device 100. As the power source 130, for example, a secondary cell may be used. The memory part 120 stores various computer programs. The memory part 120 includes a ROM, a RAM, or the like. The CPU 140 loads and executes the computer programs stored in the memory part 120, and thereby, functions as an operating system 150 (OS 150), a display control part 190, a sound processing part 170, a 10-axis sensor processing part 167, an input processing part 168, an application interface 165 (API 165), and an image processing part 160.

The OS 150 used in the embodiment is Android (registered trademark). In Android, it is impossible to perform a plurality of controls corresponding to respective detection results detected from a plurality of sensors. In the embodiment, Android is used as the OS 150, however, other OS may be used in other embodiments.

The display control part 190 generates control signals for controlling the right display drive part 22 and the left display drive part 24. Specifically, the display control part 190 individually controls drive ON/OFF of the right LCD 241 by a right LCD control part 211, drive ON/OFF of a right backlight 221 by a right backlight control part 201, drive ON/OFF of the left LCD 242 by a left LCD control part 212, drive ON/OFF of a left backlight 222 by a left backlight control part 202, etc. with the control signals. Thereby, the display control part 190 controls the respective generation and output of image lights by the right display drive part 22 and the left display drive part 24. For example, the display control part 190 may allow both the right display drive part 22 and the left display drive part 24 to generate image lights, allow only one of the parts to generate image light, or allow neither of them to generate image lights. The display control part 190 transmits the respective control signals for the right LCD control part 211 and the left LCD control part 212 via the transmission parts 51 and 52. Further, the display control part 190 transmits the respective control signals for the right backlight control part 201 and the left backlight control part 202.

The sound processing part 170 acquires sound signals contained in the contents, amplifies the acquired sound signals, and supplies the signals to a speaker (not shown) within the right earphone 32 and a speaker (not shown) within the left earphone 34 connected to the coupling member 46. Note that, for example, in the case where the Dolby (registered trademark) system is employed, processing on the sound signals is performed and different sounds at the varied frequencies or the like are output from the respective right earphone 32 and left earphone 34.

The 10-axis sensor processing part 167 specifies the line-of-sight direction of the user US based on the orientation of the image display unit 20 detected by the 10-axis sensor 66. The 10-axis sensor processing part 167 transmits a signal for changing the angle of a camera formed in the radio control car 300 based on the specified line-of-sight direction via the communication part 132 to the radio control car 300. The details of the camera of the radio control car 300 will be described later. The 10-axis sensor processing part 167 and the 10-axis sensor 66 correspond to a second detection unit in the appended claims and the detected orientation of the image display unit 20 corresponds to a display unit state in the appended claims.

The input processing part 168 acquires the operation received by the operation part 135 and the angle and the angular velocity of the control unit 10 detected by the gyro sensor 9, performs various kinds of processing thereon, and then, transmits signals based on the processing to the API 165. The operation received by the operation part 135 includes input operations to the track pad 14, the arrow key 16, and the power source switch 18. The input processing part 168 transmits signals with respect to operations of the traveling and the traveling direction (hereinafter, simply referred to as “traveling operation”) of the radio control car 300 specified by the input operation to the operation part 135 and the angular velocity of the control unit 10 to the API 165. The details of the traveling operation of the radio control car 300 based on the processing of the input processing part 168 will be described later. The gyro sensor 9 and the input processing part 168 correspond to a first detection unit in the appended claims.

The API 165 receives the signal for changing the angle of the camera of the radio control car 300 transmitted from the 10-axis sensor processing part 167 and the signal with respect to the traveling operation of the radio control car 300 transmitted from the input processing part 168. In the embodiment, when receiving the signal for changing the angle of the camera of the radio control car 300 and the signal with respect to the traveling operation of the radio control car 300, the API 165 preferentially performs processing based on the signal with respect to the traveling operation of the radio control car 300, but does not perform processing based on the signal for changing the angle of the camera. That is, in the head mounted display device 100 of the embodiment, the processing based on the detection result of the gyro sensor 9 and the processing based on the detection result of the 10-axis sensor processing part 167 are exclusively performed. The exclusive performance refers to non-simultaneous performance. Further, the API 165 receives image signals based on an outside scenery image imaged by the camera of the radio control car 300 and transmits the image signals to the OS 150. The OS 150, the API 165, and the image processing part 160 correspond to a control unit in the appended claims.

The image processing part 160 acquires image signals contained in contents. The image processing part 160 separates synchronizing signals including a vertical synchronizing signal VSync and a horizontal synchronizing signal HSync from the acquired image signals. Further, the image processing part 160 generates clock signals PCLK using a PLL (Phase Locked Loop) circuit or the like (not shown) in response to the periods of the separated vertical synchronizing signal VSync and horizontal synchronizing signal HSync. The image processing part 160 converts the analog image signals from which the synchronizing signals have been separated into digital image signals using an A/D converter circuit or the like (not shown). Then, the image processing part 160 stores the converted digital image signals as image data (RGB data) of an object image in a DRAM within the memory part 120 with respect to each frame. Note that the image processing part 160 may execute image processing such as resolution conversion processing, various kinds of tone correction processing including adjustment of brightness and saturation, keystone correction processing, or the like on the image data as necessary.

The image processing part 160 transmits the respective generated clock signals PCLK, vertical synchronizing signal VSync, horizontal synchronizing signal HSync, and the image data stored in the DRAM within the memory part 120 via the transmission parts 51, 52. Note that the image data transmitted via the transmission part 51 is also referred to as “right eye image data” and the image data transmitted via the transmission part 52 is also referred to as “left eye image data”. The transmission parts 51, 52 function as transceivers for serial transmission between the control unit 10 and the image display unit 20.

Further, the image processing part 160 receives the image signals transmitted from the radio control car 300 via the OS 150 and allows the image display unit 20 to display the outside scenery image imaged by the camera of the radio control car 300 based on the image signals.

The interface 180 is an interface for connecting various external devices OA as supply sources of contents to the control unit 10. The external devices OA include a personal computer (PC), a cell phone terminal, a game terminal, etc., for example. As the interface 180, for example, a USB interface, a micro USB interface, an interface for memory card, or the like may be used.

The image display unit 20 includes the right display drive part 22, the left display drive part 24, the right light guide plate 261 as the right optical image display part 26, the left light guide plate 262 as the left optical image display part 28, and the 10-axis sensor 66.

The right display drive part 22 includes a reception part 53 (Rx 53), the right backlight control part 201 (right BL control part 201) and the right backlight 221 (right BL 221) that function as a light source, the right LCD control part 211 and the right LCD 241 that function as a display device, and the right projection system 251. The right backlight control part 201 and the right backlight 221 function as the light source. The right LCD control part 211 and the right LCD 241 function as the display device. Note that the right backlight control part 201, the right LCD control part 211, the right backlight 221, and the right LCD 241 are also collectively referred to as “image light generation part”.

The reception part 53 functions as a receiver for serial transmission between the control unit 10 and the image display unit 20. The right backlight control part 201 drives the right backlight 221 based on the input control signal. The right backlight 221 is a light emitter such as an LED or electroluminescence (EL), for example. The right LCD control part 211 drives the right LCD 241 based on the clock signal PCLK, the vertical synchronizing signal VSync, the horizontal synchronizing signal HSync, and the right-eye image data input via the reception part 53. The right LCD 241 is a transmissive liquid crystal panel in which a plurality of pixels are arranged in a matrix.

The right projection system 251 includes a collimator lens that brings the image light output from the right LCD 241 into parallelized luminous fluxes. The right light guide plate 261 as the right optical image display part 26 guides the image light output from the right projection system 251 to the right eye RE of the user US while reflecting the light along a predetermined optical path. Note that the right projection system 251 and the right light guide plate 261 are also collectively referred to as “light guide part”.

The left display drive part 24 has the similar configuration as that of the right display drive part 22. The left display drive part 24 includes a reception part 54 (Rx 54), the left backlight control part 202 (left BL control part 202) and the left backlight 222 (left BL 222) that function as a light source, the left LCD control part 212 and the left LCD 242 that function as a display device, and the left projection system 252. The left backlight control part 202 and the left backlight 222 function as the light source. The left LCD control part 212 and the left LCD 242 function as the display device. Note that the left backlight control part 202, the left LCD control part 212, the left backlight 222, and the left LCD 242 are also collectively referred to as “image light generation part”. Further, the left projection system 252 includes a collimator lens that brings the image light output from the left LCD 242 into parallelized luminous fluxes. The left light guide plate 262 as the left optical image display part 28 guides the image light output from the left projection system 252 to the left eye LE of the user US while reflecting the light along a predetermined optical path. Note that the left projection system 252 and the left light guide plate 262 are also collectively referred to as “light guide part”.

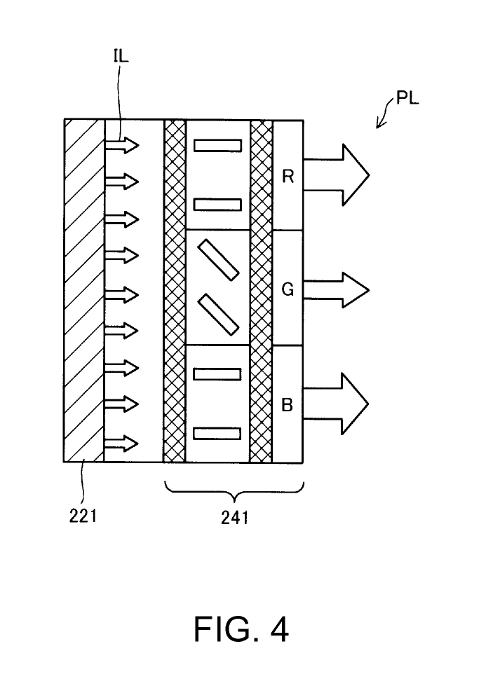

FIG. 4 is an explanatory diagram showing image lights output by the image light generation part. The right LCD 241 drives the liquid crystal in the respective pixel positions arranged in the matrix to change the transmittance of the light to be transmitted through the right LCD 241, and thereby, modulates illumination light IL radiated from the right backlight 221 into effective image light PL representing an image. This applies to the left side. Note that the backlight system is employed in the embodiment as shown in FIG. 4, however, a configuration that outputs image light using the front light system or the reflection system may be employed.

### A-3. Configuration of Radio Control Car

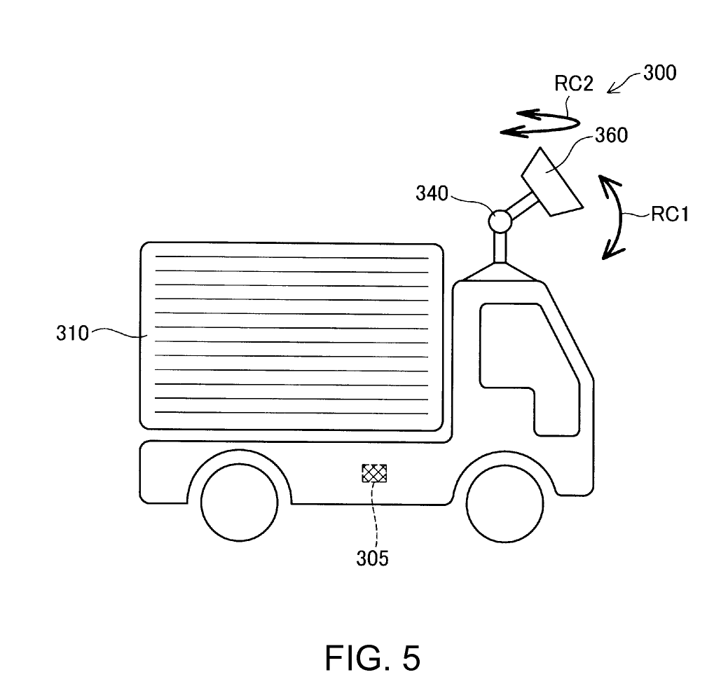

FIG. 5 is an explanatory diagram showing an outer configuration of the radio control car 300. As shown in FIG. 5, the radio control car 300 has a main body part 310, a camera 360, a joint 340 that connects the main body unit 310 and the camera 360, and a communication part 305 that makes wireless communication with the communication part 132 of the head mounted display device 100. The main body unit 310 has a battery and travels based on signals received by the communication part 305. Further, as shown in FIG. 5, the main body unit 310 includes tires and allows the radio control car 300 to travel by the traveling operation received by the operation part 135. Note that the traveling in the embodiment includes moving forward and backward and refers to other states than the halt state of the radio control car 300. The main body unit 310 changes the traveling direction of the radio control car 300 by changing the orientation of the front tires in response to the angular velocity of the control unit 10 detected by the gyro sensor 9. The camera 360 images the outside scenery in the front direction of the radio control car 300 and acquires an outside scenery image. In the embodiment, the camera 360 is a monocular camera, however, may be a stereo camera in other embodiments. Further, the direction in which the camera 360 performs imaging (hereinafter, also referred to as “imaging direction”) is not limited to the traveling direction, but variously modified. The camera 360 corresponds to an imaging unit in the appended claims.

The joint 340 connects the main body unit 310 and the camera 360 so that the relative angle between the main body unit 310 and the camera 360 may be changed within a fixed range. That is, the camera 360 may image other outside sceneries than that in the front direction of the radio control car 300. The joint 340 changes the imaging direction of the camera 360 along a trajectory RC1 and a trajectory RC2 in response to the line-of-sight direction of the user US received via the communication part 305. The communication part 305 receives signals for controlling the imaging direction of the camera 360 and the traveling operation of the radio control car 300 transmitted from the communication part 132 of the head mounted display device 100. Further, the communication part 305 transmits the outside scenery image imaged by the camera 360 as image signals to the communication part 132 of the head mounted display device 100.

### A-4. Remote Operation Processing

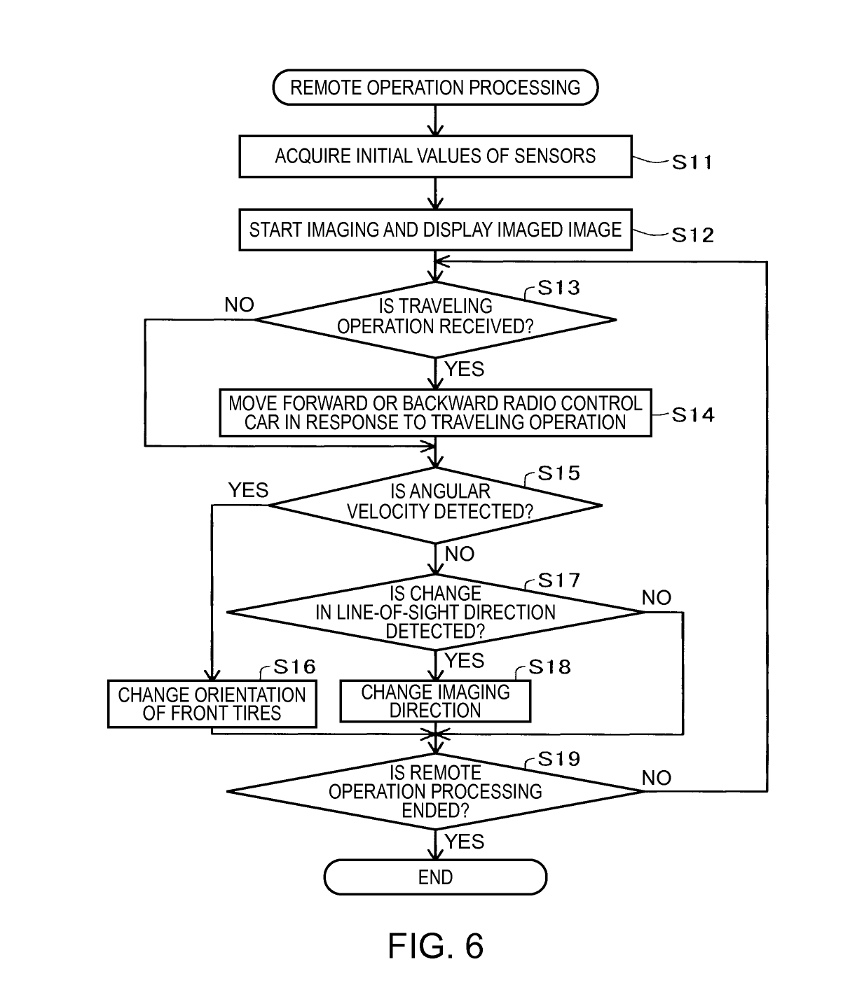

FIG. 6 is an explanatory diagram showing a flow of remote operation processing. In the remote operation processing, the radio control car 300 is remotely operated based on the traveling operation received by the operation part 135 and the line-of-sight direction of the user US specified by the 10-axis sensor 66 and the 10-axis sensor processing part 167 and the camera 360 of the radio control car 300 images an outside scenery image. FIG. 6 shows the flow of processing performed after activation of the head mounted display device 100 and the radio control car 300 in the remote operation processing.

In the remote operation processing, first, the gyro sensor 9 and the input processing part 168 acquire the location of the control unit 10 as an initial value and the 10-axis sensor 66 and the 10-axis sensor processing part 167 acquire the orientation of the image display unit 20 as an initial value (step S11). The input processing part 168 and the 10-axis sensor processing part 167 perform various kinds of processing based on changes with respect to the acquired initial values. When the initial values are acquired, the camera 360 of the radio control car 300 starts imaging of the outside scenery and the image processing part 160 allows the image display unit 20 to display the imaged outside scenery image (step S12). At the start of imaging, the orientation of the camera 360 is directed in the traveling direction and the horizontal direction.

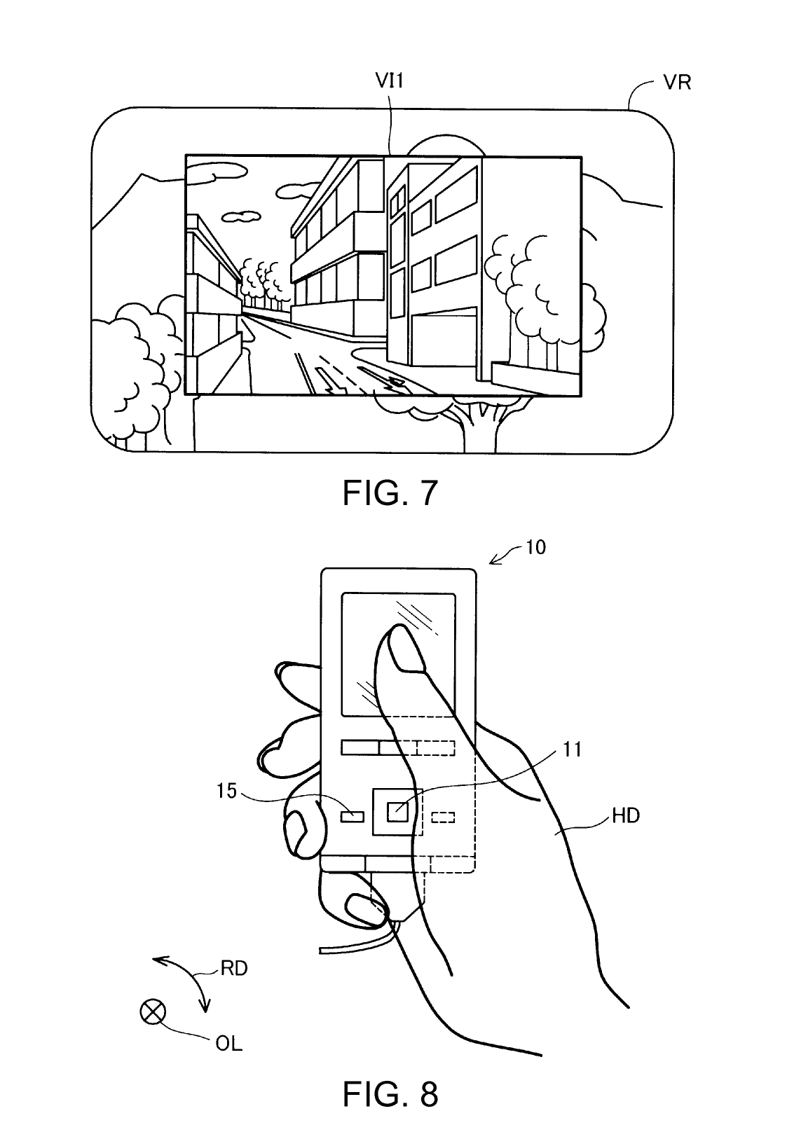

FIG. 7 is an explanatory diagram showing an example of a visual range VR visually recognized by the user US in the remote operation processing. As shown in FIG. 7, in the embodiment, an imaged image VI1 imaged by the camera 360 is visually recognized in the center part of the line of sight of the user US. The user US sees through the optical image display parts 26, 28 and visually recognizes the outside scenery as a real image in other parts than the imaged image VI1.

After the processing at step S12 in FIG. 6, the input processing part 168 monitors the traveling operation received by the operation part 135 (step S13). In the embodiment, in the mode in which the radio control car 300 is remotely operated, when the enter key 11 of the operation part 135 is pressed, the radio control car 300 moves forward and, when the brightness change key 15 of the operation part 135 is pressed, the radio control car 300 moves backward. When neither the enter key 11 nor the brightness change key 15 is pressed, the radio control car 300 halts. If the operation part 135 and the input processing part 168 detect the button operation of pressing the enter key 11 or the brightness change key 15 (step S13: YES), the API 165 moves the radio control car 300 forward or backward (step S14).

After the processing at step S14 or if the traveling operation is not detected in the processing at step S13 (step S13: NO), the gyro sensor 9 and the input processing part 168 monitor the detection of the angular velocity of the control unit 10 (step S15). If the angular velocity of the control unit 10 is detected (step S15: YES), the API 165 changes the orientation of the front tires of the radio control car 300 (step S16).

FIG. 8 is an explanatory diagram showing an example of the angular velocity of the control unit 10, which changes according to operations by the user US. FIG. 8 shows a state in which the control unit 10 is held by a right hand HD of the user US and none of the enter key 11 and the brightness change key 15 is pressed. The gyro sensor 9 detects an angular velocity along a trajectory RD in the circumferential direction around an axis OL perpendicular to the operation surface of the control unit 10. For example, when the angular velocity of the control unit 10 along the trajectory RD in the clockwise direction is detected, the API 165 tilts the front tires of the radio control car 300 to the right with respect to the traveling direction. In this case, the traveling direction of the radio control car 300 is changed to the right. The input processing part 168 determines an amount of change of the tilt of the front tires in response to the magnitude of the angular velocity detected by the gyro sensor 9, and transmits a signal of the determined amount of change to the API 165. In this manner, the orientation of the radio control car 300 is changed according to the detected angular velocity of the control unit 10 along the trajectory RD, and thereby, the user US may determine the traveling direction of the radio control car 300 by operating the control unit 10 like a steering wheel of an automobile.

In the processing at step S15 in FIG. 6, if the angular velocity of the control unit 10 is not detected (step S15: NO), the 10-axis sensor 66 and the 10-axis sensor processing part 167 monitor the detection of changes in line-of-sight direction of the user US (step S17). If a change in line-of-sight direction is detected (step S17: YES), the API 165 changes the imaging direction of the camera 360 of the radio control car 300 in response to the change in line-of-sight direction of the user US (step S18). The API 165 changes the imaging direction of the camera 360 along the trajectory RC1 and the trajectory RC2 (FIG. 5) in correspondence with the motion of the head of the user US along the respective trajectory RN1 and trajectory RN2 (FIG. 2). When the location of the radio control car 300 and the imaging direction of the camera 360 change, the display image displayed on the image display unit 20 also changes.

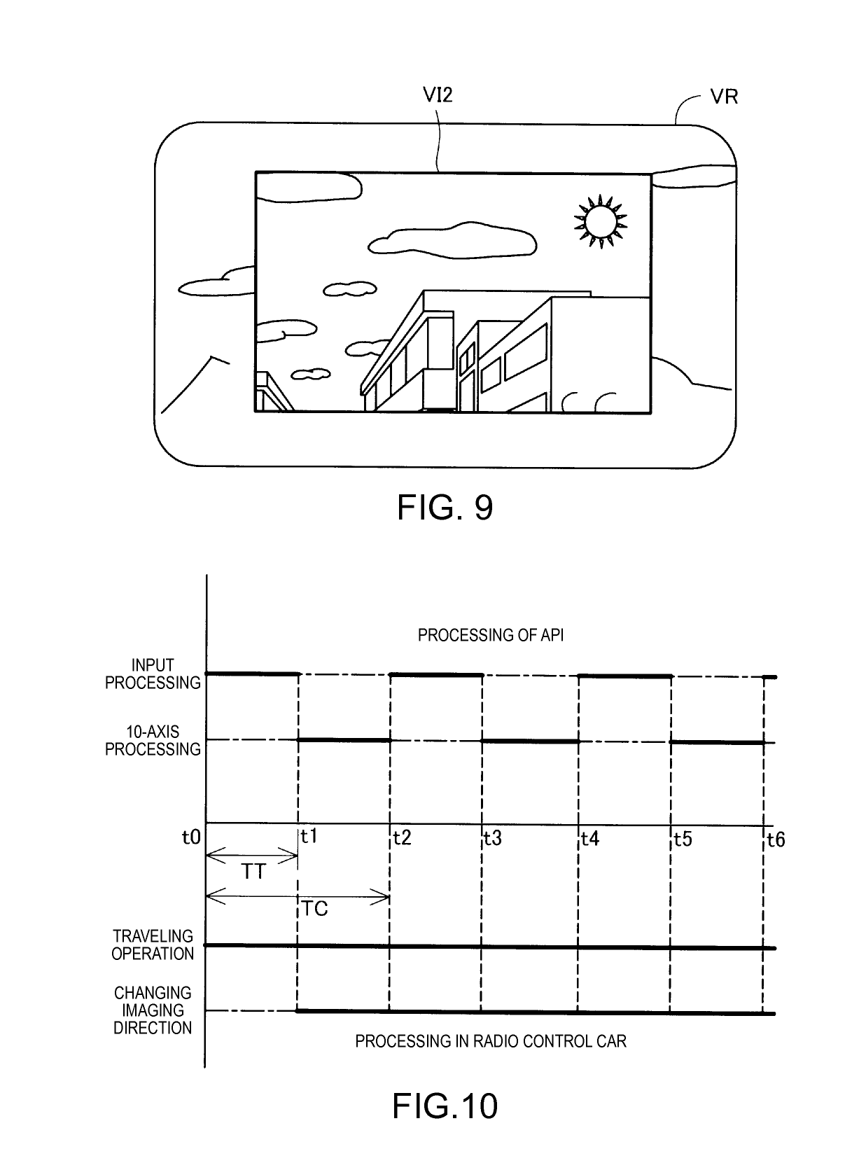

FIG. 9 is an explanatory diagram showing an example of the visual range VR visually recognized by the user US in the remote operation processing. FIG. 9 shows the visual range VR visually recognized by the user US when the head of the user US moves along the trajectory RN1 and the line-of-sight direction of the user US is directed upward with respect to the initial value. As shown in FIG. 9, the user US visually recognizes an outside scenery image in the changed imaging direction of the imaging by the camera 360 as a display image VI2. The display image VI2 is an outside scenery image of the upper part than the imaged image VI1 with respect to the horizontal direction, and has the same size as the imaged image VI1 as a displayed image. Further, the user US visually recognizes the outside scenery through the optical image display parts 26, 28 as a real image in the other parts than the displayed image VI2. Note that, compared to the visual range VR shown in FIG. 7, the line-of-sight direction of the user US is directed upward, and the outside scenery visually recognized through the visual range VR shown in FIG. 9 is the outside scenery of the upper part than the outside scenery shown in FIG. 7 with respect to the horizontal direction.

After step S16 or step S18 in FIG. 6 or if no change in line-of-sight direction is detected in the processing in step S17 (step S17: NO), the operation part 135 monitors reception of a predetermined operation of ending the remote operation processing (step S19). If the operation of ending the remote operation processing is not received (step S19: NO), the control unit 10 repeats the processing at step S13 and subsequent steps. If the operation of ending the remote operation processing is received (step S19: YES), the control unit 10 ends the remote operation processing. As shown in the above described remote operation processing, if the angular velocity of the control unit 10 is detected by the gyro sensor 9, the API 165 changes the orientation of the front tires of the radio control car 300 regardless of whether or not a change in line-of-sight direction of the user US has been detected by the 10-axis sensor 66. The processing based on the detection result of the gyro sensor 9 corresponds to a first control in the appended claims and the processing based on the detection result of the 10-axis sensor processing part 167 corresponds to a second control in the appended claims.

As described above, in the remote operation system 500 using the head mounted display device 100 in the embodiment, the gyro sensor 9 and the input processing part 168 detect the angular velocity as the state of the control unit 10 in which the operation part 135 is formed. Further, the 10-axis sensor 66 and the 10-axis sensor processing part 167 specify the orientation as the state of the image display unit 20, and the API 165, the OS 150, and the image processing part 160 change the orientation of the camera 360 of the radio control car 300 in correspondence with the specified orientation of the image display unit 20 and allow the image display unit 20 to display the outside scenery image imaged by the camera 360. Accordingly, in the remote operation system 500 of the embodiment, with respect to detection results of a plurality of sensors, a plurality of controls corresponding to the respective detection results may be performed.

Further, in the remote operation system 500 of the embodiment, the 10-axis sensor 66 and the 10-axis sensor processing part 167 provided in the image display unit 20 detect the change in orientation of the image display unit 20 and the gyro sensor 9 and the input processing part 168 formed in the control unit 10 detect the angular velocity as the change in location of the control unit 10. Accordingly, in the remote operation system 500 of the embodiment, operations corresponding to the plurality of detection results detected from the line-of-sight direction of the user US and the motion of the control unit 10 are performed, and thereby, the operations are not complex for the user US, the user US may intuitively perform the operations, and the convenience of the user is improved.

Further, in the remote operation system 500 of the embodiment, when simultaneously receiving the signal based on the detection result of the gyro sensor 9 and the signal based on the detection result of the 10-axis sensor 66, the API 165 exclusively performs the two processings based on the signals. Accordingly, in the remote operation system 500 of the embodiment, when a plurality of detection results are respectively processed by a plurality of sensors, the two processings are not simultaneously performed, but the processing based on one detection result is performed by the OS 150. Thus, it is not necessary to change the software itself of the OS 150 and the development period of the head mounted display device 100 and the remote operation system 500 may be made shorter.

Furthermore, in the remote operation system 500 of the embodiment, when simultaneously receiving the signal based on the detection result of the gyro sensor 9 and the signal based on the detection result of the 10-axis sensor 66, the API 165 preferentially performs processing based on the signal with respect to the traveling operation of the radio control car 300, but does not perform processing based on the signal for changing the angle of the camera. Accordingly, in the remote operation system 500 of the embodiment, the processing based on one detection result is preferentially performed, and thereby, erroneous motions of the head mounted display device 100 and the radio control car 300 may be reduced.

In the remote operation system 500 of the embodiment, the camera 360 of the radio control car 300 images the outside scenery and the imaging direction is changed in response to the orientation of the image display unit 20. Accordingly, in the remote operation system 500 of the embodiment, the line-of-sight direction of the user US and the imaging direction of the camera 360 are associated, and thereby, the imaging direction may be naturally changed in response to the direction in which the user US desires visual recognition and the convenience of the user US is improved.

In addition, in the remote operation system 500 of the embodiment, the imaged image VI1 and the displayed image VI2 displayed on the image display unit 20 are different outside scenery images as shown in FIGS. 7 and 9 in response to the change in line-of-sight direction of the user US. Accordingly, in the remote operation system 500 of the embodiment, the displayed image is changed in response to the operation and the state change of the user US, and the convenience of the user US is improved.

### B. MODIFIED EXAMPLES

The invention is not limited to the above described embodiment, but may be implemented in various forms without departing from the scope thereof. The following modifications may be made, for example.

### B1. Modified Example 1

In the embodiment, when the change in line-of-sight direction of the user US is detected and the angular velocity of the control unit 10 is detected, the API 165 preferentially performs the processing based on the angular velocity of the control unit 10, however, the processing performed by the API 165 is not limited to that, but various modifications may be made. For example, the processing based on the change in line-of-sight direction may be preferentially performed by the API 165, or which processing is preferentially performed may be determined by the user US depending on the operation received by the operation part 135.

Further, the processing based on the change in line-of-sight direction and the processing based on the angular velocity of the control unit 10 may be time-divisionally performed. FIG. 10 is an explanatory diagram showing relationships between time and processing in processings time-divisionally performed. As shown in FIG. 10, the API 165 divides the processing time into periods TT and alternately performs processing based on the signal with respect to the traveling operation transmitted from the input processing part 168 (hereinafter, also referred to as “input processing”) and the signal with respect to the orientation of the image display unit 20 transmitted from the 10-axis sensor processing part 167 (hereinafter, also referred to as “10-axis sensor processing”). For example, as shown in FIG. 10, the input processing is performed in the period TT from time t0 to time t1, the 10-axis sensor processing is performed in the period TT from time t1 to time t2, and the input processing is performed again in the period TT from time t2 to time t3. The API 165 transmits a signal of processing performed in a period TC having a length twice the length of the period TT to the radio control car 300 in the period TT. Specifically, the signal of the processing with respect to the traveling operation performed by the radio control car 300 in the period TC from time t0 to time t2 is transmitted in the period TT from time t0 to time t1, and the signal of the processing with respect to changing of the imaging direction performed by the camera 360 of the radio control car 300 is transmitted in the period TT from time t1 to time t2. Accordingly, in the radio control car 300, the processing of the traveling operation and the changing of the imaging direction is continuously performed unlike the processing of the API 165. In the remote operation system. 500 using the head mounted display device 100 of the modified example, although the API 165 performs processing corresponding to one detection result only at a specific time with respect to the detection results of the plural sensors, a plurality of processings are continuously performed on the result of the processing. Thus, while the load of the processing of the API 165 at the specific time is suppressed, the continuous processing in the radio control car 300 may be performed.

In the example shown in FIG. 10, the input processing and the 10-axis sensor processing are alternately performed in the periods TT, however, they may be not necessarily performed in the equal periods TT or alternately. The times at which the input processing and the 10-axis sensor processing are performed may be variously modified. For example, in one processing, a period longer than the period TT may be employed. Further, the input processing and the 10-axis sensor processing are performed not alternately, but the input processing may be performed in one of three periods TT and the 10-axis sensor processing may be performed in the other two periods TT. Further, settings of the periods TT and the periods TC may be different depending on the kinds of processing or freely made by the operation of the user US. Furthermore, the relationship between the period TT and the period TC may be variously modified. For example, the period TT and the period TC may have equal lengths, or the period TC may be longer than twice the length of the period TT. The period TC and the period TT may be different depending on the kinds of processing or freely set by the operation of the user US.

### B2. Modified Example 2

In the embodiment, the 10-axis sensor 66 as the position sensor provided in the image display unit 20 detects the state of the image display unit 20 and the gyro sensor 9 as the sensor contained in the control unit 10 and detecting the location and the change in location of the control unit 10 acquires the acceleration acting on the control unit 10, however, the forms of the respective sensors may be variously modified. For example, the orientation of the control unit 10 and the change in location of the image display unit 20 may be detected by a camera provided in another part than the control unit 10 and the image display unit 20, and the display image of the image display unit 20 may be controlled based on the detection results. Further, as the position sensor and the sensor that detects the location and the change in location of the control unit 10, a gyro sensor, an acceleration sensor, a geomagnetic sensor, an atmospheric pressure sensor, or the like may be used.

In place of the 10-axis sensor 66 provided in the image display unit 20, a 10-axis sensor may be provided in the control unit 10 separately from the gyro sensor 9. For example, input to the track pad 14 is converted by the gyro sensor 9 and the input processing part 168 and output, and the traveling operation of the radio control car 300 and the imaging direction of the camera 360 may be changed depending on the change in acceleration detected by the 10-axis sensor provided in the control unit 10.

Further, in the embodiment, the traveling operation of the radio control car 300 and the changing of the imaging direction of the camera 360 are performed depending on the angular velocity of the control unit 10 and the line-of-sight direction of the user US, however, what is controlled depending on the detection results of various sensors may be variously modified. For example, the display location, the size, the kind, etc. of the displayed image displayed on the image display unit 20 may be changed in response to the detection results of various sensors. Further, what is controlled depending on the detection result may be sound output by the sound processing part 170 and the earphones 32, 34 or vibration of the image display unit 20 by the control unit 10. Furthermore, scroll sensitivity of a mouse accompanying a personal computer, assignment of keys of the mouse, etc. may be set depending on the detection results of the sensors. In addition, assignment of various commands for operation of applications including video contents and games displayed on the image display unit 20 may be set depending on the detection results of the sensors.

Further, combinations of the detection results of various sensors may be set depending on predetermined operations or the detection results of the 10-axis sensor 66. Furthermore, as the operation of the radio control car 300, for example, an acceleration sensor may be provided in the control unit 10, the traveling speed of the radio control car 300 may be set based on the acceleration of the control unit along the direction of gravitational force, and the orientation of the front tires of the radio control car 300 may be changed based on the acceleration of the control unit 10 along the horizontal direction orthogonal to the direction of gravitational force. Moreover, for example, when the 10-axis sensor 66 detects an angular velocity equal to or more than a threshold value, the user US may be judged to desire visual recognition of a transmitted outside scenery, not an imaged image, and a range for display of an imaged image may be changed to be smaller or the display of the imaged image may be changed to non-display. In addition, what is controlled may be determined depending on the combinations of the detection results of various sensors. For example, major adjustment may be made to the traveling speed and the traveling direction of the radio control car 300 in response to the angular velocity detected by the gyro sensor 9 and minor adjustment may be made in response to the angular velocity detected by the 10-axis sensor 66.

### B3. Modified Example 3

In the embodiment, the operation part 135 is formed in the control unit 10, however, the form of the operation part 135 may be variously modified. For example, a user interface as the operation part 135 may be provided separately from the control unit 10. In this case, the operation part 135 is separated from the control unit 10 with the power source 130 etc. formed therein, and the part may be downsized and the operability of the user US is improved.

For example, the image light generation part may include an organic EL (Organic Electro-Luminescence) display and an organic EL control unit. Further, for example, for the image generation part, in place of the LCD, an LCOS (Liquid crystal on silicon, LCOS is a registered trademark), a digital micromirror device, or the like may be used. Furthermore, for example, the invention may be applied to a laser retina projection-type head mounted display.

Further, for example, the head mounted display device 100 may have a form having an optical image display part that covers only a part of the eye of the user US, in other words, a form of an optical image display part that does not completely cover the eye of the user US. Furthermore, the head mounted display device 100 may be the so-called monocular-type head mounted display. In addition, the head mounted display device 100 is the binocular-type optically-transmissive head mounted display, however, the invention may be similarly applied to a head mounted display device in other forms including a video-transmissive type, for example.

Further, ear-fit-type or headband-type earphones may be employed or the earphones may be omitted. Furthermore, the head mounted display device may be formed as a head mounted display device mounted on a vehicle of an automobile, an airplane, or the like, for example. In addition, for example, the head mounted display device may be formed as a head mounted display device build in a body protector including a hardhat.

### B4. Modified Example 4

The configuration of the head mounted display device 100 in the embodiment is just an example and may be variously modified. For example, one of the arrow key 16 and the track pad 14 provided in the control unit 10 may be omitted or another operation interface such as an operation stick may be provided in addition to the arrow key 16 and the track pad 14 or in place of the arrow key 16 and the track pad 14. Further, the control unit 10 may have a configuration to which an input device such as a keyboard or mouse can be connected and receive input from the keyboard or the mouse.

Furthermore, as the image display unit, in place of the image display unit 20 worn like spectacles, an image display unit of another system such as an image display unit worn like a hat may be employed, for example. Further, the earphones 32, 34 may be appropriately omitted. Furthermore, in the above described embodiment, the LCD and the light source are used as the configuration of generating image light, however, in place of them, another display device such as an organic EL display may be employed. In addition, in the above described embodiment, the 10-axis sensor 66 is used as the sensor that detects the motion of the head of the user US, however, in place of the sensor, a sensor including one or more of an acceleration sensor, an angular velocity sensor, a geomagnetic sensor, and an atmospheric pressure sensor may be used.

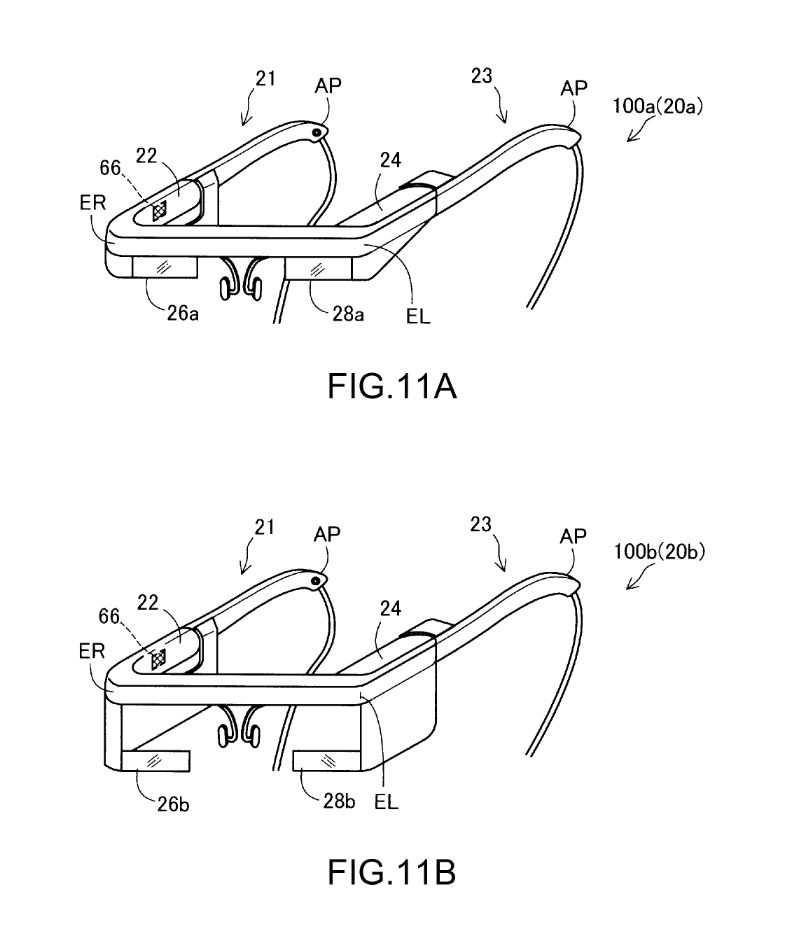

FIGS. 11A and 11B are explanatory diagrams showing outer configurations of head mounted display devices in modified examples. In the case of the example of FIG. 11A, the difference from the head mounted display device 100 shown in FIG. 2 is that an image display unit 20a includes a right optical image display part 26a in place of the right optical image display part 26 and a left optical image display part 28a in place of the left optical image display part 28. The right optical image display part 26a is formed to be smaller than the optical members of the above described embodiment, and provided in the obliquely upper part of the right eye of the user US when a head mounted display device 100a is worn. Similarly, the left optical image display part 28b is formed to be smaller than the optical members of the above described embodiment, and provided in the obliquely upper part of the left eye of the user US when the head mounted display device 100a is worn. In the case of the example of FIG. 11B, the difference from the head mounted display device 100 shown in FIG. 2 is that an image display unit 20b includes a right optical image display part 26b in place of the right optical image display part 26 and a left optical image display part 28b in place of the left optical image display part 28. The right optical image display part 26b is formed to be smaller than the optical members of the above described embodiment, and provided in the obliquely lower part of the right eye of the user US when the head mounted display is worn. The left optical image display part 28b is formed to be smaller than the optical members of the above described embodiment, and provided in the obliquely lower part of the left eye of the user US when the head mounted display is worn. As described above, it is only necessary that the optical image display unit is provided near the eye of the user US. Further, the sizes of the optical members forming the optical image display unit may be arbitrary, and the head mounted display device 100 in which the optical image display unit covers only a part of the eye of the user US, in other words, the optical image display unit does not completely cover the eye of the user US may be implemented.

Further, in the above described embodiment, the head mounted display device 100 may guide image lights representing the same image to the left and right eyes of the user US and allows the user to visually recognize a two-dimensional image, or may guide image lights representing different images to the left and right eyes of the user US and allows the user to visually recognize a three-dimensional image.

Furthermore, in the above described embodiment, a part of the configuration implemented by hardware may be replaced by software, or, conversely, a part of the configuration implemented by software may be replaced by hardware. For example, in the above described embodiment, the image processing part 160 and the sound processing part 170 may be implemented by the CPU 140 reading out and executing computer programs, however, these functional parts may be implemented by a hardware circuit.

In addition, in the case where part or all of the functions of the invention are implemented by software, the software (computer programs) may be stored and provided in computer-readable media. In the invention, “computer-readable media” include not only portable recording media such as a flexible disk or a CD-ROM but also internal memory devices within the computer such as various RAMs and ROMs and external memory devices fixed to the computer such as a hard disk.

Further, in the above described embodiment, as shown in FIGS. 2 and 3, the control unit 10 and the image display unit 20 are formed as separate configurations, however, the configurations of the control unit 10 and the image display unit 20 are not limited to those, but may be variously modified. For example, all or part of the configurations formed in the control unit 10 may be formed inside of the image display unit 20. Further, the power source 130 in the embodiments may be singly formed and replaceable, or the configuration formed in the control unit 10 may be redundantly formed in the image display unit 20. For example, the CPU 140 shown in FIG. 3 may be formed in both the control unit 10 and the image display unit 20, or the functions performed by the CPU 140 formed in the control unit 10 and the CPU formed in the image display unit 20 may be separated.

In addition, the control unit 10 may be built in a PC and the image display unit 20 may be used in place of the monitor of the PC, or a wearable computer attached to cloths of the user US, in which the control unit 10 and the image display unit 20 are integrated, may be employed.

The invention is not limited to the above described embodiments and modified examples, but may be implemented in various configurations without departing from the scope thereof. For example, the technical features in the embodiments and the modified examples corresponding to the technical features in the respective forms described in “SUMMARY” may be appropriately replaced or combined in order to solve part or all of the above described problems or achieve part or all of the above described advantages. Further, the technical features may be appropriately deleted unless they are described as essential features in the specification.

The entire disclosure of Japanese Patent Application No. 2013-257674, filed Dec. 13, 2013 is expressly incorporated by reference herein.

What is claimed is:

1. A head mounted display device comprising:
an operation unit that receives an operation;
a first detection unit that detects an operation unit state as at least one of a location and an orientation of the operation unit;
an image display unit that forms image light based on image data and allows a user to visually recognize the image light as a virtual image when worn on a head of the user;
a second detection unit that detects a display unit state as at least one of a location and an orientation of the image display unit; and
a control unit that performs a first control based on the detected operation unit state and performs a second control different from the first control based on the detected display unit state with respect to the head mounted display device.

2. The head mounted display device according to claim 1, wherein the first detection unit is provided in the operation unit, and
the second detection unit is provided in the image display unit.

3. The head mounted display device according to claim 2, wherein the first detection unit detects a change in location of the operation unit as the operation unit state, and
the second detection unit detects a change in orientation of the image display unit as the display unit state.

4. The head mounted display device according to claim 1, wherein the control unit exclusively performs the first control and the second control.

5. The head mounted display device according to claim 4, wherein the control unit performs one of the first control and the second control when the change in location of the operation unit is detected and the change in orientation of the display unit is detected.

6. The head mounted display device according to claim 4, wherein the control unit time-divisionally performs the first control and the second control.

7. The head mounted display device according to claim 2, further comprising an imaging unit that images an outside scenery,
wherein the second control is processing of changing a direction in which imaging is performed by the imaging unit based on the change in orientation of the image display unit.

8. The head mounted display device according to claim 1, wherein at least one of the first control and the second control is processing of controlling the image light.

9. A method of controlling a head mounted display device including an operation unit that receives an operation, a first detection unit that detects an operation unit state as at least one of a location and an orientation of the operation unit, an image display unit that forms image light based on image data and allows a user to visually recognize the image light as a virtual image when worn on a head of the user, and a second detection unit that detects a display unit state as at least one of a location and an orientation of the image display unit, the method comprising performing a first control based on the detected operation unit state and performing a second control different from the first control based on the detected display unit state with respect to the head mounted display device.
